(19) United States
(12) Patent Application Publication
(10) Pub. No.: US 2013/0320175 A1
(43) Pub. Date: Dec. 5, 2013

(54) MOUNTING ARRANGEMENT

(71) Applicant: Hilti Aktiengesellschaft, Schaan (LI)

(72) Inventor: Lorcan KEMPLE, Hard (AT)

(21) Appl. No.: 13/907,626

(22) Filed: May 31, 2013

(30) Foreign Application Priority Data
Jun. 1, 2012 (DE) 102012209267.6

(51) Int. Cl. F16B 7/04

(52) U.S. Cl. CPC F16B 7/0493
USPC 248/316.1

(57) ABSTRACT

A mounting device is disclosed. The mounting device includes a profile rail having a longitudinal slot that is limited by two parallel inner walls and a fastening part. The fastening part includes a t-nut disposed in the interior of the profile rail, a clamping body connected to the t-nut from the outside, and a spring unit that can be tensed by a movement of the clamping body away from the t-nut. The clamping body is twistable relative to the t-nut and to the profile rail from a sliding angle position into a pre-mounting angle position. The fastening part includes an inclined activation plane that pushes the clamping body away from the profile rail and that tenses the spring unit while increasing the contact pressure of the t-nut on the inner bars when the clamping body is twisted out of the sliding angle position and into the pre-mounting angle position.

This application claims the priority of German Patent Document No. DE 10 2012 209 267.6, filed Jun. 1, 2012, the disclosure of which is expressly incorporated by reference herein.

### BACKGROUND AND SUMMARY OF THE INVENTION

The invention relates to a mounting arrangement. Such a mounting arrangement comprises a profile rail having a longitudinal slot that is limited by two parallel inner bars and a fastening part for fastening a mounted part to the profile rail, with the fastening part having: a t-nut that is disposed in the interior of the profile rail and that reaches behind the inner bars of the profile rail, a clamping body that is connected to the t-nut and that acts against the profile rail from the outside, and a spring unit that may be tensed by a movement by the clamping body away from the t-nut.

A generic mounting arrangement is known, for example, from European Patent Document No. EP 0 687 822 A2.

The object of the invention is to provide a mounting arrangement by means of which a mounted part can be attached in a particularly simple, fast, reliable, and secure fashion with particularly little expense.

A mounting arrangement according to the invention is characterized in that the clamping body is rotatable relative to the t-nut and relative to the profile rail from a sliding angle position to a pre-mounting angle position around a rotational axis that preferably runs through the longitudinal slot, and in that the fastening part, in particular the clamping body, comprises at least one inclined activation plane that pushes the clamping body away from the profile rail and which tenses the spring unit by increasing the surface pressure of the t-nut on the inner bars when the clamping body is rotated out of the sliding angle position and into the pre-mounting angle position.

A basic idea underlying the invention lies in a fastening part having a twist lock, which is activated by a rotation of the clamping body relative to the profile rail: if the clamping body is rotated relative to the profile rail from the sliding position to the pre-mounting position, the at least one inclined activation plane forces the clamping body away from the profile rail, i.e., the inclined activation plane acts as a control curve or connecting member. Because the t-nut reaches behind the inner bars of the profile rail, the t-nut is unable to follow this translational motion of the clamping body away from the profile rail and instead remains behind in the profile rail. As a result, the clamping body moves away from the t-nut in the direction of the rotational axis and the spring unit acting between the t-nut and the clamping body becomes tensed under the effect of the increasing contact pressure of the t-nut acting from the inside on the inner bars of the profile rail. Due to the increase in contact pressure, the friction of the t-nut against the profile rail is increased, thus at least provisionally securing the fastening part against displacement along the profile rail, in particular along the longitudinal slot.

According to the invention, the t-nut need not be rotated in order to reach the pre-mounting position, which allows for a particularly simple handling. In particular, the t-nut may reach behind the inner bars in a captive fashion, i.e., the t-nut may be embodied in such a way that the t-nut cannot be removed through the longitudinal slot, but rather only through the side faces of the mounting rail. This measure allows a particularly high degree of reliability to be achieved.

In particular, the t-nut may have a hammerhead-shaped or compressed t-shaped cross-section, with the side bars of the hammerhead-shaped cross-section reaching behind the inner bars of the profile rail and/or with the middle bar of the hammerhead-shaped cross-section protruding toward the clamping body. In particular, the middle bar may protrude into the longitudinal slot of the profile rail, which may facilitate the insertion of the t-nut into the profile rail. The at least one inclined activation plane may be provided on the clamping body, on the profile rail, and/or on the t-nut.

The clamping body and/or the t-nut are preferably composed of a metallic material. The profile rail preferably has a constant cross-section in the longitudinal direction and, in particular, may be embodied as a continuously cast part. It is suitable for at least one face side of the profile rail, i.e., one of the two sides that limit the profile rail in the longitudinal direction, to be open such that the t-nut may be inserted there. In particular, the t-nut may be untoothed, i.e., embodied without teeth.

It is preferable for the clamping body to comprise at least one groove for accepting the profile rail at least regionally, in particular in the sliding angle position, with at least one of the inclined activation planes being disposed in the groove. According to this embodiment, at least one of the inclined activation planes mentioned above, which move the clamping body away from the t-nut into the pre-mounting position upon rotation, is embodied by a limiting surface of the groove. This embodiment can be advantageous with regard to production costs, in particular because this embodiment can allow the clamping body with the at least one groove to be embodied as a continuously cast part. Moreover, this allows the at least one groove to also have a guidance function, thus further increasing reliability. Preferably, the at least one groove can comprise two of the inclined activation planes, which are located opposite one another in the groove. The at least one groove can particularly accommodate one of the inner bars of the profile rail. It is suitable for the at least one groove to run parallel to the longitudinal slot in the sliding angle position, i.e., in the longitudinal direction of the profile rail, and crosswise, in particular at a right angle, to the longitudinal direction of the profile rail in the pre-mounting position.

It is particularly preferred for the clamping body to comprise two grooves for accommodating the profile rail in a regional fashion, in particular in the sliding angle position of the clamping body; it is suitable for each groove to comprise at least one of the inclined activation planes, in particular two of the inclined activation planes. It is useful for the two grooves to run parallel to one another. In particular, provision can be made for the first groove to accommodate the first inner bar and for the second groove to accommodate the second inner bar in the sliding angle position of the clamping body.

Moreover, it is advantageous for the clamping body and the t-nut to have play relative to the inner bars when the clamping body is in the sliding angle position such that the fastening part may be freely slid along the longitudinal gap. This can be realized, for example, by a stop that limits the approach of the t-nut to the clamping body. The abovementioned embodiment is able to allow particularly simple positioning of the fastening part along the profile rail. Being freely slidable can particularly include the t-nut and the clamping body being positionable relative to the profile rail in the sliding angle position in such a way that the t-nut and the clamping body do not touch at least the inner bars, and preferably do not touch the entire profile rail.

Accordingly, the contact pressure of the t-nut on the inner bars in the sliding angle position of the clamping body can also equal zero.

For example, it may be advantageous with regard to design effort for the fastening part to comprise a stud bolt that connects the clamping body and the t-nut. It is particularly preferred for tightening the stud bolt to allow the mounted part to be fixed between the clamping body and the profile rail in which the t-nut is located, preferably in a form-locking fashion, or, additionally or alternately, to be clamped there. In particular, tightening the stud bolt can allow a final mounted state to be achieved in which the mounted part is fixed between the clamping body and the profile rail and in which the inner bars, as compared to the pre-mounting state, are clamped in a particularly fixed fashion between the clamping element and the t-nut.

It is preferable for a bore, particularly a through bore, with an inner thread to be provided in the t-nut that corresponds to an outer thread of the stud bolt. It is suitable for a through bore for the stud bolt to be provided in the clamping body that is large enough that the stud bolt is axially displaceable therein, and that may particularly be embodied as a stepped bore. The stud bolt preferably comprises a head that has a larger diameter than the through bore in the clamping body, such that the head is able to exert an axial force on the clamping body in the final mounted state.

Another preferred embodiment lies in the spring unit being disposed on the side of the clamping body facing away from the t-nut. This can be advantageous, for example, with regard to production expense.

In particular, provision may be made for the spring unit to comprise a compression spring that, in particular, surrounds the stud bolt. This can be advantageous with regard to reliability, among other things, particularly because it is particularly simple to place a compression spring in a captive fashion. It is useful for the compression spring to be disposed between the head of the stud bolt and the clamping body and/or for the compression spring to be supported on the head of the stud bolt on one side and on the clamping body on the other side, preferably, but not necessarily, in a direct fashion.

Another advantageous refinement of the invention lies in the t-nut being arranged captively in the interior of the profile rail through the longitudinal slot. This can particularly involve the t-nut being impossible to remove through the longitudinal slot regardless of its position relative to the profile rail and instead for the t-nut to be insertable into or removable from the profile rail only via one open face side of the profile rail. This can even further increase reliability.

It is particularly preferable for the t-nut to be disposed in the interior of the profile rail in a non-rotational fashion, particularly relative to the rotational axis of the clamping body, which in particular can mean that the t-nut can be rotated around the rotational axis at most by a negligible angle, i.e., within tolerances of, for example, less than 20°, in particular less than 10°, 5°, or 2°. This ensures a defined rotational position of the t-nut in the profile rail, which can further increase reliability. In particular, the dimensions of the t-nut can be greater in the longitudinal direction of the profile rail than transverse thereto.

Preferably, provision may be made for the clamping body in its pre-mounted angle position to be at least partially liftable from the profile rail while increasing the tension of the compression spring, in particular in such a way that part of the mounted part can be inserted between the clamping body and the profile rail. This can be achieved in that the spring unit has a sufficiently large spring range. According to this embodiment, the clamping body can also serve to at least provisionally fasten the mounted part, which is inserted between the clamping body and the profile rail and clamped between the clamping body and the profile rail by the effect of the spring element.

By subsequently tightening the stud bolt, the spring force of the spring element can be further increased and a final mounted state achieved in which the t-nut is pulled against the inner bars of the profile rail with a high contact pressure and/or in which the mounted part is secured in a frictionally engaged or form-locking fashion. It is therefore particularly preferred for the mounted part in its final mounted state to be fixed, in particular clamped, between the clamping body and the profile rail. In this final mounted state, the clamp body preferably continues to be in an angle position in which the grooves run at an angle, in particular at a right angle, to the longitudinal axis of the profile rail. In the final mounted state, the clamping body can be connected to the t-nut in a flush manner, i.e., the spring element can be at its maximum compression in this state. In particular, in the final mounted state, the head of the stud bolt can rest directly on the clamping body.

In particular, provision may be made for the mounted part to be fastened to be another profile rail. This additional profile rail may also have a constant cross-section in the longitudinal direction and may preferably be embodied as a continuously cast part.

Moreover, it is preferred for the clamping part to comprise a receiver groove for a connecting flange of the mounted part. In this manner, a particularly secure connection can be achieved. It is suitable for the receiver groove to run parallel to the at least one groove mentioned above. In particular, the mounted part can engage in the receiver groove in a hook-like fashion.

Another preferred embodiment of the invention lies in the clamping body being embodied in an L shape with a contact leg for resting against the profile rail and a securing leg for resting against the mounted part. The securing leg may, in particular, form a stop that limits a motion of the mounted part transversely to the profile rail and/or prevents the mounted part from tilting, which could potentially twist the connecting flange out of the receiver groove. The contact leg and the securing leg may preferably run at a right angle to one another. For an even better connection of the mounted part, the securing leg may also be toothed. The receiver groove is preferably disposed at the transition between the contact leg and the securing leg. In particular, provision may be made for the clamping body, in particular its securing leg, to be in contact with the mounted part in two areas that are separate from one another, namely in the region of the receiver groove and in a contact region. Between these areas, the securing leg is preferably located at a distance from the mounted part.

The invention also relates to a method for fastening a mounted part to a mounting arrangement according to the invention comprising the following steps in an embodiment:

inserting the t-nut of the fastening part into the profile rail;

sliding the fastening part along the profile rail;

twisting the clamping body out of the sliding position and into the pre-mounting position;

inserting the mounted part between the clamping body and the profile rail; and

fixing the mounted part between the clamping body and the profile rail, in particular in such a way that a final mounted state is achieved.

In particular, the mounted part may be fixed by tightening the stud bolt. The mounted part may also be provided as a component of the mounting arrangement.

The invention allows the installer to slide the fastening part along the profile rail into a desired position with very little friction and then bring the fastening part into a pre-mounting state in which the combined shape of the profile rail and the fastening part prevents the fastening part from sliding away from the desired position. In order to achieve the pre-mounted state, the installer rotates the clamping body of the fastening part by 90°. This tenses the spring unit and, at the same time, causes a clamping pressure on the inner bars of the rail because the inner bars are wedged between the clamping body and the t-nut. In the pre-mounted state, the fastening part remains in its position and, in particular, cannot be pulled out of the slot due to the form fit of the t-nut in the profile rail. If a small amount of force is applied, however, the fastening part may still be moved back and forth along the profile rail and thus be placed in its final position. In the pre-mounted state, the spring unit has a sufficient range of spring remaining that the fastening part is able to grip the mounted part. Finally, the stud bolt is tightened, thus attaining the final mounted state.

The mounting arrangement according to the invention may in particular be a carrying structure for solar panels, preferably photovoltaic panels. The fastening part according to the invention may be used for connecting two rails, in particular at a right angle to one another.

The invention shall be described in greater detail below with reference to preferred exemplary embodiments, which are shown schematically in the attached figures.

### BRIEF DESCRIPTION OF THE DRAWINGS

FIG. 1 is a perspective view of a mounting arrangement according to the invention with the clamping body in the sliding position;

FIG. 2 is a side view of the mounting arrangement according to FIG. 1 with the clamping body in the sliding position;

FIG. 3 is a longitudinal cross-section view of the mounting arrangement according to FIG. 1 with the clamping body in the sliding position;

FIG. 4 is a detail view of the mounting arrangement according to FIG. 1 from the face side of the profile rail similar to FIG. 2 with the clamping body in the sliding position;

FIG. 5 is a perspective view of the mounting arrangement according to FIG. 1 with the clamping body in the pre-mounting position;

FIG. 6 is a longitudinal cross-section view of the mounting arrangement according to FIG. 1 with the clamping body in the pre-mounting position;

FIG. 7 is a perspective view of the mounting arrangement according to FIG. 1 in the final mounted state with a mounted part;

FIG. 8 is a longitudinal cross-section view similar to FIG. 3 of the mounting arrangement according to FIG. 1 in the final mounted state with a mounted part; and

FIG. 9 is a detail view from the side similar to FIG. 4 of a second embodiment of a mounting arrangement according to the invention in the sliding state, with the t-nut not being shown for the sake of clarity.

### DETAILED DESCRIPTION OF THE DRAWINGS

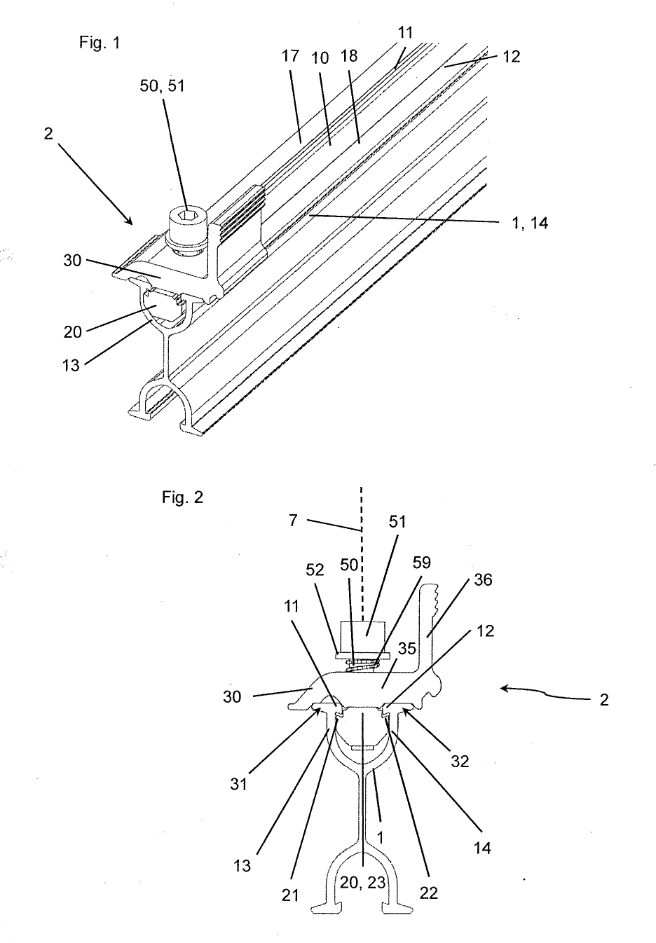

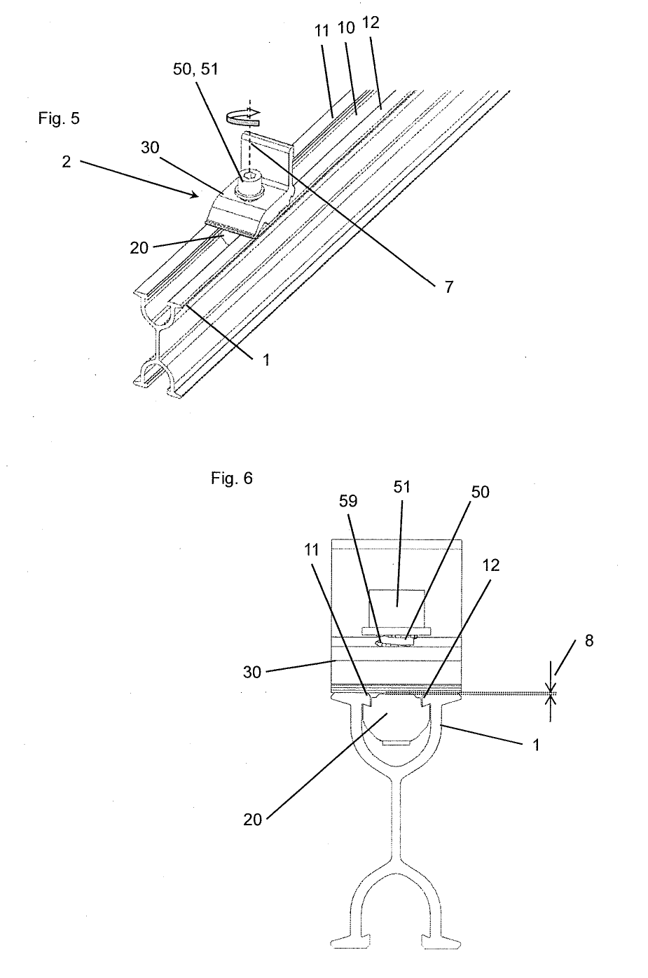

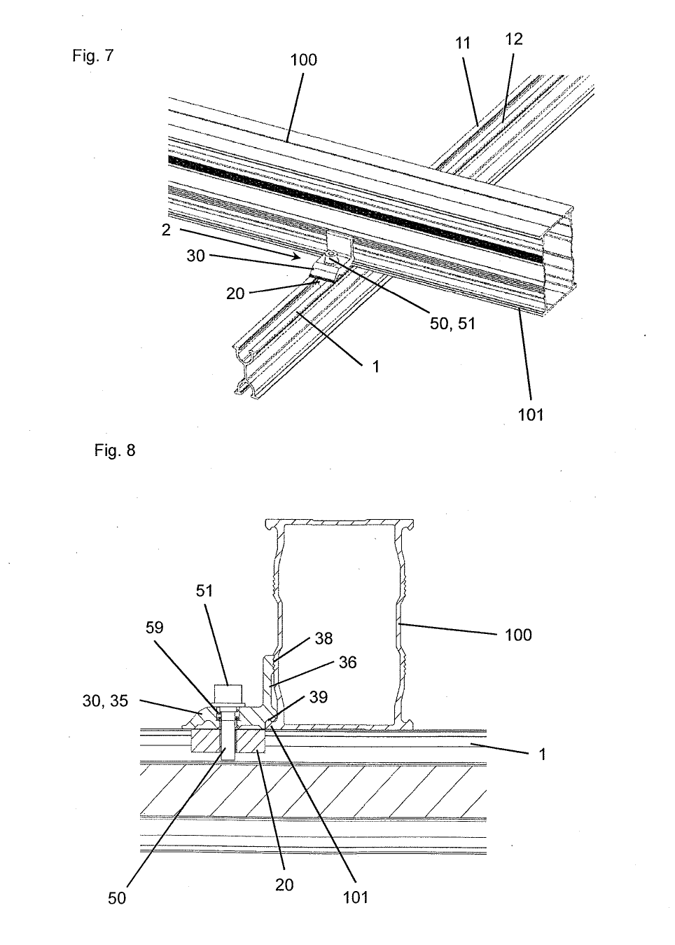

FIGS. 1 to 8 show a first exemplary embodiment of a mounting arrangement according to the invention in various operating states, namely in the sliding state in FIGS. 1 to 4, in the pre-mounted state in FIGS. 5 and 6, and in the final mounted state in FIGS. 7 and 8.

As is shown by way of example in FIGS. 1 and 2, the mounting arrangement first comprises a profile rail 1 having a longitudinal slot 10 running along the profile rail 1. This slot 10 is flanked by two inner bars 11 and 12 of the profile rail 1.

The mounting arrangement further comprises a fastening part 2 that extends through the longitudinal slot 10. The fastening part 2 comprises a t-nut 20 that is located at least partially, in particular completely, inside the profile rail 1, as well as a clamping body 30 that is located at least partially, in particular completely, outside the profile rail 1. The clamping body 30 rests on the profile rail 1, specifically on the side of the profile rail 1 in which the longitudinal slot 10 is located, and, inter alia, on the inner bars 11 and 12. The clamping body 30 and the t-nut 20 are connected via a stud bolt 50 that passes freely through the clamping body 30 and is screwed into the t-nut 20.

As is particularly shown by FIG. 2, the t-nut 20 has a hammerhead shape in cross-section having a middle bar 23 and two side bars 21 and 22 that protrude on opposite sides of the middle bar 23. The two side bars 21 and 22 each reach behind one of the inner bars 11 and 12 of the profile rail 1, and the middle bar 23 protrudes between the two inner bars 11 and 12.

The clamping body 30 is designed with an L-shaped cross-section with one contact leg 35 and one securing leg 36 protruding approximately perpendicular thereto. The contact leg 35 rests against the profile rail 1 and the securing leg 36 serves to secure a mounted part 100, which will be discussed in greater detail below.

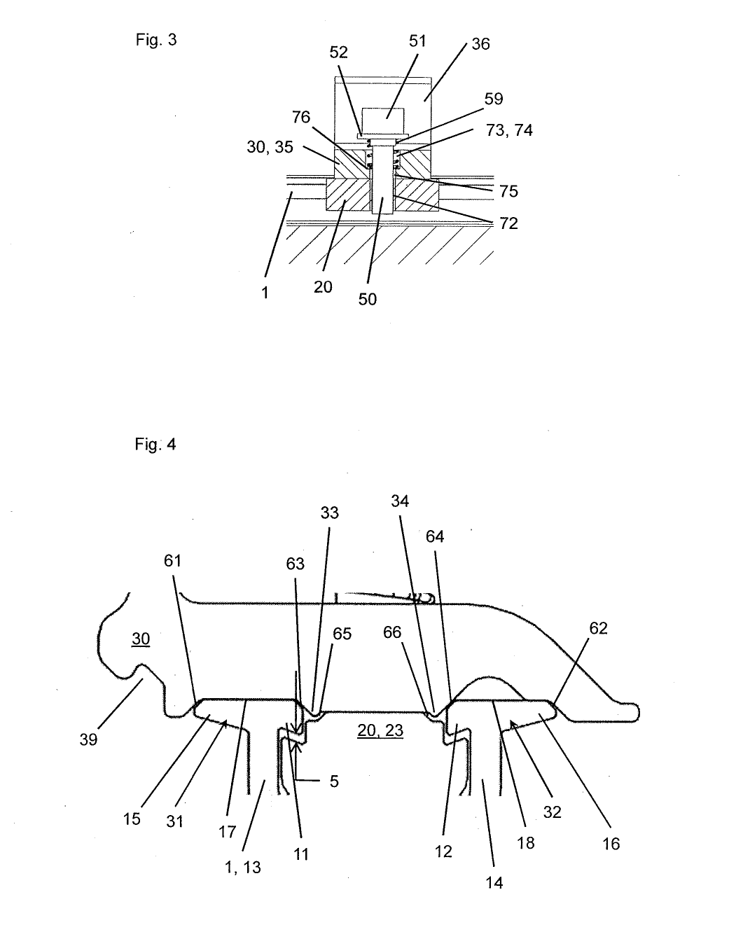

As is shown in particular in FIG. 3, the stud bolt 50 is inserted through a through bore 73 in the contact leg 35 of the clamping body 30. This through bore 73 is designed to have a larger cross-section than the shaft of the stud bolt 50 in such a way that the shaft of the stud bolt 50 moves freely in the axial direction in the through bore 73. A through bore 72 is provided in the t-nut 20 with an inner thread that corresponds with the outer thread of the stud bolt 50. The stud bolt 50 is screwed into this inner thread.

The through bore 73 of the clamping body 30 is embodied as a stepped bore. As such, the through bore 73 has a region 74 with a larger diameter and a region 75 with a smaller diameter, with the region 75 with the smaller diameter being located closer to the t-nut 20 than the region 74 with the larger diameter. A graduated ring 76 is formed between the two regions 74 and 75 of the through bore 73.

The stud bolt 50 comprises a head 51 to which a rotating tool may be applied in order to rotate the shaft of the bolt. The head 51 has a sufficiently large cross-section that the head 51 cannot pass through the through bore 73 of the clamping body 30. In particular, the cross-section of the head 51 is larger in cross-section than the region 74 with the larger diameter. Thus, the head 51 of the stud bolt 50 is able to exert an axial force on the clamping body 30. In the exemplary embodiment shown, the head 51 is embodied in multiple parts and also comprises a washer 52 that may be rotated relative to the shaft of the stud bolt 50. Optionally, the head 51 may also comprise other distancing bodies, in particular fixed distancing bodies.

The fastening part 2 further comprises a spring unit having a compression spring 59. This compression spring 59 surrounds the stud bolt 50 and is supported on one side on the head 51 of the stud bolt 50, namely on its washer 52, and on the other side on the clamping body 30, namely on its graduated ring 76.

As may particularly be seen in FIGS. 2 and 4, the profile rail 1 comprises two side walls 13, 14 running along the longitudinal slot 10 that may be connected to one another on the side of the profile rail 1 facing away from the longitudinal slot 10. The first inner bar 11 as well as the first outer bar 15 on the side opposite the first inner bar 11 are disposed on the end of the first side wall 13. The second inner bar 12 as well as a second outer bar 16 on the side opposite the second inner bar 12 are disposed on the end of the second side wall 14. The inner bars 11 and 12 point toward the respective adjacent side wall 14 and 13, while the outer bars 15 and 16 point away from the respective adjacent side wall 14 and 13. The first inner bar 11, the first outer bar 15, and the first side wall 13 form a T-shaped structure in cross-section. Analogously, the second inner bar 12, the second outer bar 16, and the second side wall 14 form a T-shaped structure in cross-section. The first inner bar 11 and the first outer bar 15 form a first flat contact surface 17 and the second inner bar 12 and the second outer bar 16 form a second flat contact surface 18. In a top view of the slot 10, the two contact surfaces 17 and 18 are located on opposite sides of the slot 10. The profile rail 1 lies on the contact surfaces 17 and 18, in particular in the sliding position and/or the pre-mounting position and/or also in the final mounted position on the clamping body 30.

As may particularly be seen in FIGS. 2 and 4, the clamping body 30 comprises two parallel, straight grooves 31 and 32 in its contact leg 35 on the bottom side facing away from the head 51 of the stud bolt 50 and the profile rail 1. The grooves 31 and 32 run parallel to the bending edge located between the contact leg 35 and the securing leg 36 and extend over the entire clamping body 30. The profile rail 1 is regionally accommodated in these grooves 31 and 32 in the pre-mounting position shown in FIGS. 1 to 4. In particular, in the pre-mounting position, the inner bars 11 and 12 as well as the outer bars 15 and 16 are at least regionally accommodated in the grooves 31 and 32 such that the contact surfaces 17 and 18 rest against the groove base of the respective grooves 31 and 32.

As may be particularly seen from FIG. 4, the clamping body 30 comprises two positioning bars 33, 34 that extend into the longitudinal slot 10 in the sliding position shown in FIG. 4, in particular between the two inner bars 11 and 12 of the profile bar 1.

As FIG. 4 particularly also shows, the fastening part 2 comprises a plurality of inclined activation planes disposed in pairs, whose function will be explained in detail below. Each pair comprises an inclined plane on the clamping body 30 and a corresponding inclined plane opposite it on the profile rail 1 or on the t-nut 20. A first, outside pair of inclined activation planes 61 is provided on the clamping body 30 in the first groove 31 and on the opposite first outer bar 15. Analogously, a second outside pair of inclined activation planes 62 is provided on the clamping body 30 in the second groove 32 and on the opposite second outer bar 16. A first inside pair of inclined activation planes 63 is provided on the clamping body 30 in the first groove 31, in particular on the first positioning bar 33 and on the opposite first inner bar 11. Analogously, a second inner pair of inclined activation planes 64 is provided on the clamping body 30 in the second groove 32, in particular on the second positioning bar 34 and on the opposite second inner bar 12. Another first pair of inclined activation planes 65 is provided on the clamping body 30 on the first positioning bar 33 and on the middle bar 23 of the t-nut 20. Another second pair of inclined activation planes 66 is provided on the clamping body 30 on the second positioning bar 34 and on the middle bar 23 of the t-nut 20. By virtue of the plurality of the inclined planes and/or their arrangement in pairs, it is possible for any twisting to be counteracted in a particularly effective fashion. Fundamentally, however, it may also be sufficient for the inclined activation planes not to be paired such that at least part of the inclined activation planes do not have any corresponding opposite inclined activation plane.

During mounting, the t-nut 20 of the fastening part 2 is inserted frontally into the profile rail 1. The clamping body 30 is disposed relative to the t-nut 20 in such a way that the grooves 31 and 32 disposed in the clamping body 30 run in the longitudinal direction of the profile rail 1. This results in a sliding state, which is shown in FIGS. 1 to 4. In this sliding state, the clamping body 30 rests against the t-nut 20, in particular against its middle bar 23, and the clamping body 30 and the t-nut 20 surround the two inner bars 11 and 12 of the profile rail 1 with a certain play 5 (see FIG. 4) such that the fastening part 2 may be slid along the profile rail 1 with only a small amount of friction.

When the provided end position of the fastening part 2 along the profile rail 1 has approximately been reached, the installer may, as shown in FIG. 5, rotate the clamping body 30 relative to the t-nut 20 around a rotational axis 7 that coincides with the longitudinal axis of the stud bolt 50 into the pre-mounting position shown in FIGS. 5 and 6, in particular by 90°. This rotational movement causes the bars 11, 12, 15, and 16 of the profile rail 1 to move out of the grooves 31 and 32 of the clamping body 30 and the inclined activation planes 61 to 66 to push the clamping body 30 away from the profile rail 1 and t-nut 20 in an axial direction relative to the rotational axis 7, such that a distance 8 exists from that point forward between the clamping body 30 and the t-nut 20 (see. FIG. 6). The axial movement of the clamping body 30 away from the t-nut 20 causes the compression spring 59 to be compressed and tensed. The tension of the compression spring 59 seizes the profile rail, in particular its bars 11, 12, 15, and 16, between the clamping body 30 and the t-nut 20, such that a greater force is necessary to slide the fastening part 2 along the profile rail 1 in the pre-mounting state than in the sliding state. Accidental sliding is thus counteracted, but intentional sliding continues to be possible.

Subsequently, the installer can arrange the mounted part 100, which is embodied as a hollow profile rail, as shown in FIGS. 7 and 8, on the fastening part 2. The shaft of the stud bolt 50 is designed to be long enough that the installer is able to lift the mounting body 30 in the pre-mounting position away from the profile rail 1 in such a way that a connecting flange 101 of the mounted part 100 can be inserted between the clamping body 30 and the profile rail 1.

Then the installer can tighten the stud bolt 50 until a final mounted state is achieved in which the clamping body 30 and the t-nut 20 are screwed together in a flush manner, i.e., in which axial forces between the stud bolt 50 and the clamping body 30 are no longer transferred only indirectly via the compression spring 59 but rather also directly from the stud bolt 50 to the clamping body 30. This final mounted state is shown in FIGS. 7 and 8. In the final mounted state, the profile rail 1 is clamped between the t-nut 20 and the clamping body 30 with a clamping force that has increased yet again from the pre-mounted state such that, in the final mounted state, a considerably greater force is required to slide the fastening part 2 along the profile rail 1 as compared to the pre-mounted state.

In the final mounted state, the head 51 of the stud bolt 50 rests against the clamping body 30. However, at most, the head 51 penetrates partially into the through bore 73 such that the compression spring 59 retains a residual length. The upper region 74 of the through bore 73 with the greater diameter thus forms a protective space for the compression spring 59.

As may be particularly seen in FIGS. 4 and 8, the clamping body 30 comprises a receiver groove 39 for the connecting flange 101 of the mounted piece 100. The receiver groove 39 is open in the direction of the profile rail 1 and preferably runs parallel to the grooves 31 and 32. In particular, the receiver groove 39 may be provided at the transition between the contact leg 35 and the securing leg 36. In the final mounted state, the connecting flange 101 running between the clamping body 30 and the profile rail 1 reaches behind the receiver groove 39 in a hook-like manner. This creates a form lock between the fastening part 2, in particular its clamping body 30, and the mounted part 100, which prevents the mounting part 100 from moving transversely relative to the receiver groove 39. In the final mounted state, the mounted part 100 can be clamped between the clamping body 30 and the profile rail 1, with the clamping body 30 preferably being embodied in such a way that the clamping force is limited to the mounted part 100. Thus, the clamping body 30 can be designed in such a way that, in the final mounted state, it rests directly against the profile rail 1 such that part of the clamping force is conducted past the mounted part 100 and directly into the profile rail 1.

In the final mounted state, the securing leg 36 of the clamping body 30 also rests against the mounted part 100, specifically in a toothed contact region 38 at the end of the securing leg 36. This prevents the mounted part 100 from being twisted out of the receiver groove 39. The toothed contact region 38 lies against the mounted part 100 in a toothed counter contact region of the mounted part 100. Overall, the mounted part 100 rests against the clamping body 30 in two regions, namely in the region of the receiver groove 39 and in the contact region 38. Between these regions, the mounted part 100 and the clamping body 30 are located at a distance from one another.

The t-nut 20 is dimensioned in such a way that, at most, it can be twisted around the rotational axis 7 by only a small angle amount and such that, regardless of its position around the rotational axis 7, it cannot be pulled out of the slot 10. The t-nut 20 is therefore held in the slot 10 in a captive fashion.

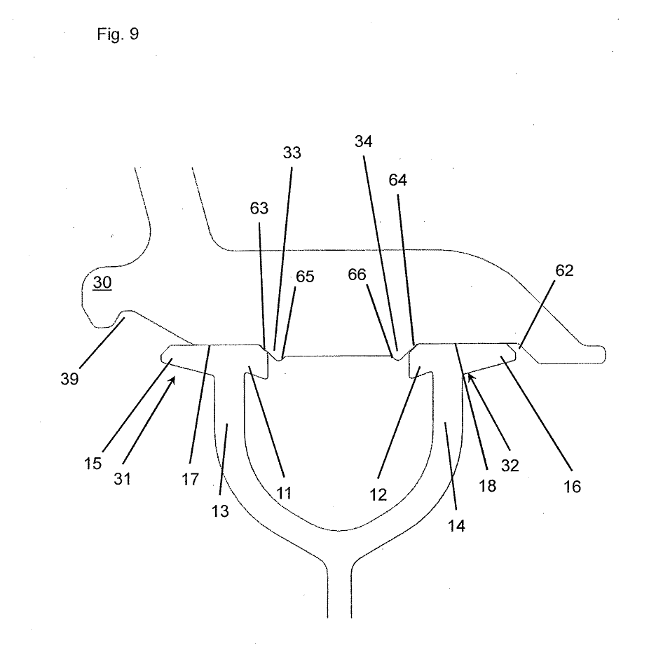

Another embodiment of a mounting arrangement according to the invention is shown in its sliding state in FIG. 9. The exemplary embodiment of FIG. 9 differs from the exemplary embodiment previously described essentially in that the receiver groove 39 transitions directly into the groove 31 in a slanting fashion. Only one pair of inclined planes 63 is present on the groove 31, whereas the outer inclined plane pair 61 from FIG. 4 is omitted in the exemplary embodiment according to FIG. 9.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A mounting arrangement, comprising:
a profile rail having a longitudinal slot that is limited by two parallel inner bars of the profile rail;
a fastening part for fastening a mounted part to the profile rail, the fastening part comprising:
a t-nut disposable in an interior of the profile rail and reachable behind the two parallel inner bars;
a clamping body connected to the t-nut and actable against the profile rail from an outside of the profile rail;
a spring unit that is tensable by a movement of the clamping body away from the t-nut;
wherein the clamping body is twistable relative to the t-nut and relative to the profile rail around a rotational axis from a sliding angle position into a pre-mounting angle position; and
an inclined activation plane, wherein the clamping body is pushable away from the profile rail by the inclined activation plane, and wherein the spring unit is tensable by the inclined activation plane while increasing a contact pressure of the t-nut on the two parallel inner bars, when the clamping body is turned out of the sliding angle position and into the pre-mounting angle position.

2. The mounting arrangement according to claim 1, wherein the clamping body includes a groove for accommodating the profile rail, wherein the inclined activation plane is disposed in the groove, and wherein the groove runs in a longitudinal direction of the profile rail in the sliding angle position and at a right angle to the longitudinal direction in the pre-mounting angle position.

3. The mounting arrangement according to claim 1, wherein when the clamping body is located in the sliding angle position, the fastening part is freely slidable along the longitudinal slot.

4. The mounting arrangement according to claim 1, wherein the fastening part further comprises a stud bolt that connects the clamping body to the t-nut.

5. The mounting arrangement according to claim 4, wherein the spring unit is a compression spring that surrounds the stud bolt.

6. The mounting arrangement according to claim 1, wherein the t-nut is captively disposable in the profile rail by the longitudinal slot and wherein the t-nut is disposable in the interior of the profile rail in a twist-proof fashion relative to the rotational axis.

7. The mounting arrangement according to claim 1, wherein in the pre-mounting angle position, the clamping body is raisable at least partially from the profile rail while increasing a tension of the spring unit.

8. The mounting arrangement according to claim 1 in combination with a mounted part, wherein in a final mounted state, the mounted part is fixed between the clamping body and the profile rail.

9. The mounting arrangement according to claim 8, wherein the mounted part is a profile rail, wherein the clamping body includes a receiver groove that receives a connecting flange of the mounted part, and wherein the clamping body is an L shape with a contact leg that rests against the profile rail and a securing leg that rests against the mounted part.

10. A method for fastening a mounted part to a mounting arrangement of claim 1, comprising the steps of:
inserting the t-nut of the fastening part into the profile rail;
sliding the fastening part along the profile rail;
twisting the clamping body out of the sliding angle position into the pre-mounting angle position;
inserting the mounted part between the clamping body and the profile rail; and
fixing the mounted part between the clamping body and the profile rail.

11. A mounting arrangement, comprising:
a profile rail having a longitudinal slot; and
a fastening part, the fastening part comprising:
a t-nut disposable in the longitudinal slot;
a clamping body connectable to the t-nut, wherein the clamping body is twistable relative to the t-nut and relative to the profile rail around a rotational axis from a sliding angle position into a pre-mounting angle position;
an inclined plane, wherein the clamping body is pushable away from the profile rail by the inclined plane when the clamping body is turned out of the sliding angle position and into the pre-mounting angle position; and
a spring unit disposable between the t-nut and the clamping body.

12. The mounting arrangement according to claim 11, wherein the inclined plane is included on the clamping body.

13. The mounting arrangement according to claim 12, wherein the t-nut includes an inclined plane and wherein, in an operative configuration, the inclined plane of the clamping body is disposed opposite from the inclined plane of the t-nut.

14. The mounting arrangement according to claim 12, wherein the profile rail includes an inclined plane and wherein, in an operative configuration, the inclined plane of the clamping body is disposed opposite from the inclined plane of the profile rail.

15. The mounting arrangement according to claim 11, wherein the clamping body is L-shaped and wherein the clamping body defines a receiver groove that receives a connecting flange of a mounted part.

16. The mounting arrangement according to claim 15, wherein the clamping body has a contact leg that is restable against the profile rail and a securing leg that is restable against a mounted part, and wherein the securing leg has a toothed contact region.

17. The mounting arrangement according to claim 11, wherein the profile rail has a U-shaped structure disposed on opposite ends of the profile rail and wherein the U-shaped structures are connected by a leg member.

18. The mounting arrangement according to claim 11, wherein the clamping body includes a groove and wherein, in an operative configuration, a sidewall of the profile rail is disposed in the groove when the clamping body is in the sliding angle position.

19. The mounting arrangement according to claim 11, wherein the clamping body includes a positioning bar and wherein, in an operative configuration, the positioning bar extends into the longitudinal slot of the profile rail when the clamping body in the sliding angle position.

20. The mounting arrangement according to claim 12, wherein the clamping body includes a groove and wherein the inclined plane is disposed in the groove.
